(19) United States
(12) Patent Application Publication
(10) Pub. No.: US 2025/0334394 A1
(43) Pub. Date: Oct. 30, 2025

(54) METHOD FOR DETERMINING A LENGTH ALONG A CENTERLINE UNDERNEATH A VEHICLE

(71) Applicant: Gulfstream Aerospace Corporation, Savannah, GA (US)

(72) Inventors: Damian P. Yanez, Savannah, GA (US); Caleb Wright, Savannah, GA (US); Tom Tanner, Savannah, GA (US); Patrick Leonard, Savannah, GA (US)

(73) Assignee: Gulfstream Aerospace Corporation, Savannah, GA (US)

(21) Appl. No.: 19/180,775

(22) Filed: Apr. 16, 2025

Related U.S. Application Data
(60) Provisional application No. 63/638,825, filed on Apr. 25, 2024.

(51) Int. Cl. G01B 11/02

(52) U.S. Cl. CPC G01B 11/026

(57) ABSTRACT

A method can include positioning a first axle jack under a vehicle between a first set of wheels at a front region with a laser device positioned on the first axle jack. The method can include positioning a second axle jack underneath the vehicle between a second set of wheels. The method can also include configuring a third axle jack underneath the vehicle between a third set of wheels. The method can also include transmitting a laser beam from the laser device to reflection points on the second axle jack and the third axle jack to measure a distance from the first axle jack to each of the reflection points. The method may also include measuring a distance from each of the reflection points to the first axle jack.

### CROSS-REFERENCE TO RELATED APPLICATIONS

This application claims the benefit of U.S. Provisional Application No. 63/638,825 filed on Apr. 25, 2024, which is incorporated herein by reference in its entirety.

### TECHNICAL FIELD

The present invention relates generally to vehicles and more specifically to determining a length along a centerline underneath a vehicle.

### BACKGROUND

Current methods to measure distances to points underneath aircraft are effective, but leave room for improvement. One such method is known as the plumb bob and steel tape method. This method, which has been employed for decades, requires a person to extend a metal tape between two fixed locations. This method yields measurements that are acceptably accurate, but which can have greater accuracy if modern advancements in the taking of measurements are employed. Furthermore, although the time and effort required to employ the plumb bob and steel tape method is acceptable, it would be preferable if the measurements could be taken more quickly and with less effort.

Accordingly, it is desirable to provide a method that can measure distances to each jacking point with greater accuracy, higher efficiency, and less effort. It is desirable to provide a system that can improve upon the current systems and provide greater accuracy, higher efficiency, and reduced effort.

### BRIEF SUMMARY

Various embodiments of a method to measure distances to jacking points underneath a vehicle are described.

In a first non-limiting embodiment, a method for determining a length along a centerline can include, but is not limited to, positioning a first axle jack within a first set of wheels at a front region underneath the vehicle with a laser device configured on the first axle jack. The method may also include, but is not limited to, positioning a second axle jack at a rear region underneath the vehicle between a second set of wheels, wherein the second axle jack is positioned at an angle to the laser device and the first axle jack. The method can also include, but is not limited to, positioning a third axle jack at the rear region underneath the vehicle between a third set of wheels, wherein the third axle jack is positioned at another angle to the laser device and the first axle jack. In addition, the method can include, but is not limited to, transmitting a laser beam from the laser device to reflection points on the second axle jack and the third axle jack to measure a distance from the first axle jack to each of the reflection points. The method may also include, but is not limited to, measuring a distance from each of the reflection points to the first axle jack.

In another non-limiting embodiment, a method for determining a length along a centerline of a vehicle can include, but is not limited to, positioning a first axle jack under a front region of the vehicle between a first set of wheels at the front region with a laser device positioned on the first axle jack. The method may also include, but is not limited to, positioning a second axle jack at a rear region underneath the vehicle between a second set of wheels and at an angle to the laser device and the first axle. The method can also include, but is not limited to, positioning a third axle jack at the rear region underneath the vehicle between a third set of wheels and at another angle to the laser device and the first axle jack. The method may also include, but is not limited to, removably mounting a plumb bob device to extend downward at the front region underneath the vehicle between the first axle jack, the laser device, the second axle jack, and the third axle jack. The method can also include, but is not limited to, transmitting a laser beam from the laser device to reflection points on the second axle jack, the third axle jack, and the plumb bob device to measure a distance from the first axle jack to each of the reflection points. In addition, the method can also include, but is not limited to, calculating the length of the centerline underneath the vehicle using the measured distances from the first axle jack to each of the reflection points.

In yet another non-limiting embodiment, a system can include, but is not limited to, a first axle jack positioned under a front region of the vehicle between a first of wheels at the front region with a laser device positioned on the first axle jack. The system can also include, but is not limited to, a second axle jack positioned at a rear region underneath the vehicle between a second set of wheels and at an angle to the laser device and the first axle jack. The system may also include, but is not limited to, a third axle jack positioned at the rear region underneath the vehicle between a third set of wheels at another angle to the laser device and the first axle jack. The system can also include, but is not limited to, a plumb bob device removably mounted to extend downwardly at the front region underneath the vehicle in between the first axle jack, the laser device, the second axle jack, and the third axle jack. The system can also include, but is not limited to, reflection points on the second axle jack, the third axle jack and the plumb bob device. The laser device transmits a laser beam to each of the reflection points to measure a distance from the first axle jack to each of the reflection points. In addition, the measured distances from each of the reflection points to the first axle jack are used to calculate the length along the centerline underneath the vehicle.

### BRIEF DESCRIPTION OF THE DRAWINGS

The present invention will hereinafter be described in conjunction with the following drawing figures, wherein like numerals denote like elements, and

FIG. 1A is a front view illustrating a first set of wheels at a nose or front region underneath a vehicle, with a first axle jack disposed under the first set of wheels in accordance with the teachings of the present disclosure;

FIG. 1B is an expanded front view of the first set of wheels of FIG. 1A, with a laser device disposed on a shelf attached to the first axle jack in accordance with the teachings of the present disclosure;

FIG. 2 is a front view illustrating a second set of wheels at a rear region underneath the vehicle with a second axle jack and a reflection point on the second axle jack underneath the second set of wheels in accordance with the teachings of the present disclosure;

FIG. 3 is a front view illustrating a third set of wheels at the rear region underneath the vehicle with a third axle jack and a reflection point on the third axle jack underneath the third set of wheels in accordance with the teachings of the present disclosure;

FIG. 4A is a perspective view illustrating a holding device and a plumb bob device in accordance with the teachings of the present disclosure;

FIG. 4B is a perspective view illustrating the holding device positioned underneath the vehicle with a string hanging from the holding device and extending to the plumb bob device (not shown in FIG. 4B) in accordance with the teachings of the present disclosure;

FIG. 4C is a side view illustrating the string hanging vertically from the holding device and extending to the plumb bob device with the plumb bob device positioned to reflect a laser beam from the laser device in accordance with the teachings of the present disclosure;

FIG. 5 is a side view illustrating a vehicle positioned over the first axle jack, the plumb bob device, the second axle jack, and the third axle jack with respective reflection points on the second axle jack, third axle jack, and the plumb bob device in accordance with the teachings of the present disclosure;

FIG. 6 is a plan view illustrating a vehicle positioned over the first axle jack, the plumb bob device, the second axle jack, and the third axle jack with respective reflection points on the second axle jack, the third axle jack, and the plumb bob device in accordance with the teachings of the present disclosure; and

FIG. 7 is a flow diagram illustrating a non-limiting embodiment of method for determining a length of a centerline underneath a vehicle in accordance with the teachings of the present disclosure.

### DETAILED DESCRIPTION

The following detailed description is merely exemplary in nature and is not intended to limit the invention or the application and uses of the invention. Furthermore, there is no intention to be bound by any theory presented in the preceding background or the following detailed description. Furthermore, other desirable features and characteristics will become apparent from the subsequent detailed description and the appended claims, taken in conjunction with the accompanying drawings.

The following exemplary embodiments illustrate methods by which a length along a centerline underneath a vehicle (e.g., an aircraft) can be measured when necessary, such as during the weighing of the vehicle. Distances from reflection points to a centerline of a first axle jack underneath the vehicle can all be measured. The Pythagorean theorem can be applied to the measured distances from the reflection points to determine the length of the centerline underneath the vehicle. As a result, a longitudinal position of a plurality of jacks underneath the vehicle along the centerline in vehicle coordinates can be determined. Further, the vehicle's longitudinal center of gravity in vehicle coordinates can be determined as well by measuring the weight at each jacking point.

At a nose region or front region underneath the vehicle, a nose axle jack or first axle jack can be positioned underneath a first set of wheels. Load cells on the first axle jack can be used during the weighing process of the vehicle. The first set of wheels can also be lifted off of the ground surface. A horizontal shelf can be attached to the first axle jack. A laser device can then be positioned on the horizontal shelf. At a back region or rear region underneath the vehicle, a left axle jack or second axle jack can be positioned underneath a second set of wheels. Load cells on the second axle jack can be weighed during the weighing process. The second set of wheels can also be lifted off of the ground surface. A point can be identified on a bottom cylinder of the second axle jack to receive a laser beam from the laser device. The second axle jack can be positioned at an angle to the first axle jack and the laser device. The measurement from the first axle jack to the second axle jack can be performed to identify a longitudinal position of both the first axle jack and the second axle jack along the centerline in vehicle coordinates.

A right axle jack or third axle jack can also be positioned at the rear region underneath the vehicle. The third axle jack can be positioned between a third set of wheels. The third axle jack can be parallel to the second axle jack. Load cells on the third axle jack can be used during the weighing process. The third set of wheels can also be lifted off the ground surface. A point on the third axle jack can then be identified on a bottom cylinder of the third axle jack. A point on the third axle jack can also be identified to receive a laser beam from the laser device. The third axle jack can be positioned at an angle to the first axle jack and the laser device. The measurement from the first axle jack to the third axle jack can also identify another longitudinal position of the first axle jack and the third axle jack along the centerline in vehicle coordinates.

A plumb bob device can be removably mounted at the front portion underneath the vehicle. The plumb bob device can be configured after the first axle jack and laser device at the front portion underneath the vehicle and be positioned ahead of the second axle jack, and third axle jack that are positioned underneath the rear region of the vehicle. A holding device can be removably mounted in a reference hole region underneath the fuselage of the vehicle. A string can be removably mounted to the holding device and extend downward. The plumb bob device can be removably mounted to the string and also extend downward. A point can be identified on a bottom portion of the plumb bob device to receive a laser beam from the laser device. As such, a position of the first axle jack relative to a reference location on the fuselage in vehicle coordinates can be identified with the measurement from the first axle jack to the plumb bob device.

Before the laser device emits a laser beam to the second axle jack, the third axle jack, and the plumb bob device, the first set of wheels, the second set of wheels, and the third set of wheels are lifted off of the ground surface on which the vehicle is positioned. Each set of wheels can be lifted off of the ground surface such that the vehicle is laterally and longitudinally level. The first set of wheels can be lifted to a greater height off of the ground surface than the second set of wheels and the third set of wheels. After the wheels of the vehicle have been lifted off of the ground surface, the second axle jack, third axle jack, and plumb bob device can then be positioned to receive a laser beam from the laser device positioned on the first axle jack.

The laser device can be rotated on the horizontal shelf to be in the line of sight of the second axle jack, the third axle jack, and the plumb bob device in various intervals. The laser beam can transmit a laser beam to a point on the second axle jack, the third axle jack, and the plumb bob device. The transmitted laser beam to the second axle jack can reflect off of a reflection point on the second axle jack back to the first axle jack. The transmitted laser beam to the third axle jack can reflect off of a reflection point on the third axle jack back to the first axle jack. In addition, the transmitted laser beam to the plumb bob device can reflect off of a reflection point on the plumb bob device back to the first axle jack.

The second axle jack, the third axle jack, and the plumb bob device can each have a reflection point in which the laser beam can come into contact with before the laser beam reflects back to the first axle jack. The distances of each reflection point to the first axle jack can be measured. In addition, an outer radius to a centerline of the second axle jack, an outer radius to a centerline of the third axle jack, an outer radius to a centerline of the plumb bob device, and an outer radius to a centerline of the first axle jack can be added to the measured distances. As such, the measured distances can include distances from the centerline of the first axle jack to the centerline of the second axle jack, and the centerline of the first axle jack to the centerline of the third axle jack. The distance from the centerline of the second axle jack to the centerline of the third axle jack can be a known distance, and can be used with the other measured distances to determine the length of the centerline underneath the vehicle. The Pythagorean theorem can be applied to the measured distances to calculate the distance of the centerline underneath the vehicle. The measured distances from the first axle jack to the second axle jack, the known distance from the second axle jack to the third axle jack, and the measured distance from the first axle jack to the third axle jack can be used within the Pythagorean theorem. As a result, the distance or length of the centerline can be determined. Moreover, the longitudinal distance along the centerline between the first axle jack and the average of the second axle jack and the third axle jack can be determined. The vehicle's longitudinal center of gravity in vehicle coordinates during a weighing procedure can thereby be determined.

As such, the distance along the centerline underneath the vehicle can be measured safely and efficiently, and the vehicle's longitudinal center of gravity in vehicle coordinates can be determined whenever necessary during a weighing procedure. In a non-limiting example, it may be necessary to measure the centerline underneath a vehicle when a vehicle is being weighed. Incorporating the laser device to transmit a laser beam to points on the second axle jack, the third axle jack, and plumb bob device can ensure greater accuracy and allow the measurements to be calculated more efficiently. In addition, the entire process can reduce the likelihood of any damage that may occur to the vehicle during the weighing of the vehicle.

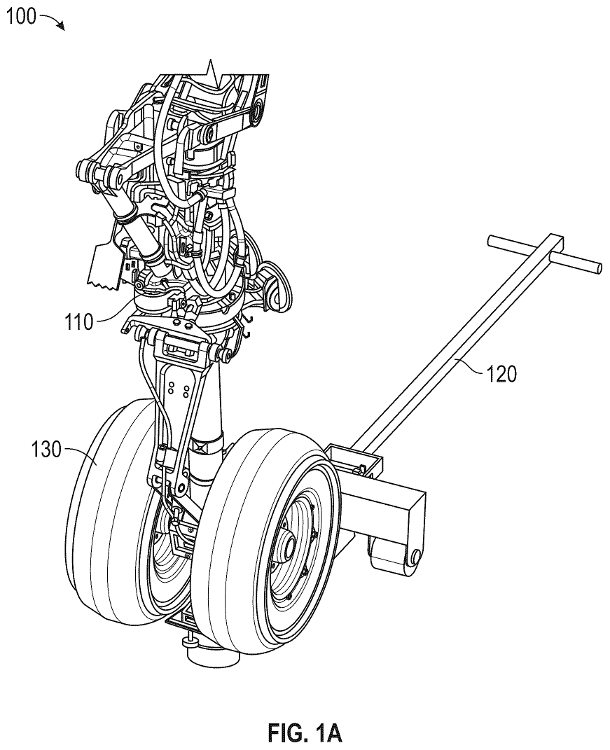

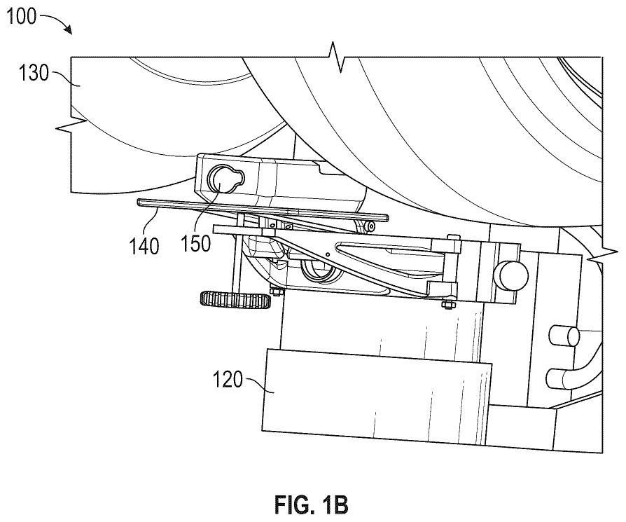

In FIG. 1A, a system 100 is illustrated with a nose landing gear 110 situated over a first axle jack 120 or nose axle jack 120. A laser device can be positioned on the first axle jack 120 to measure the distances to reflection points on a second axle jack and third axle jack positioned at a back portion underneath the vehicle or aircraft. The measured distances from the first axle jack 120 to the second axle jack and the third axle jack can determine longitudinal positions along the centerline for the first axle jack 120, the second axle jack, and the third axle jack in vehicle coordinates. In addition, the first axle jack 120 with the laser device can be used to measure a distance to a reflection point to a plumb bob device that can be removably mounted at a front region underneath the vehicle behind the first axle jack 120 and in front of the second axle jack and the third axle jack. The measurement from the first axle jack 120 to the plumb bob device can determine the position of the first axle jack 120 relative to reference location on the fuselage of the vehicle in vehicle coordinates.

Referring again to FIG. 1A, the nose landing gear 110 can be positioned at a front portion or nose region of a vehicle such as, but not limited to, an aircraft. The nose landing gear 110 can include a first set of wheels 130 that are positioned over the first axle jack 120. The first set of wheels 130 can be lifted off of the ground surface. A horizontal shelf can be configured on the first axle jack 120 that is positioned underneath the nose landing gear 110 and first set of wheels 130. The laser device can be positioned on the horizontal shelf on the first axle jack 120. After the first set of wheels 130 have been lifted off of the ground surface, and when the laser device is situated, the laser device can then transmit a laser beam to the second axle jack, third axle jack, and the plumb bob device respectively. The laser beam can be reflected from a reflection point on the second axle jack, third axle jack, and plumb bob device respectively. The distances from each reflection point to the first axle jack can be measured respectively. In addition, the outer radius to a centerline for the second axle jack, the third axle jack, the plumb bob device, and the first axle jack can be added to the measured distances. The measured distances involving the first axle jack, second axle jack, and third axle jack can then be used to measure a distance along a centerline underneath the vehicle. The distance along the centerline underneath the vehicle can extend from the centerline of the first axle jack to a point between the second axle jack and the third axle jack. The longitudinal distance along the centerline between the first axle jack 120 and the average of the second axle jack and the third axle jack can be determined. Accordingly, the vehicle's longitudinal center of gravity in vehicle coordinates during a weighing procedure can be determined.

Referring to FIG. 1B, with continued reference to FIG. 1A, another view of the system 100 is illustrated. The first set of wheels 130 are positioned over the laser device 150. The laser device 150 is configured on the horizontal shelf 140 that is attached to the first axle jack 120. The laser device 150 can be repositioned and rotated on the horizontal shelf 140 in multiple intervals to be in the line of sight of either the second axle jack, third axle jack, or plumb bob device. As such, before the laser device 150 transmits a laser beam to the second axle jack, third axle jack, and plumb bob device, the laser device 150 can be rotated on the horizontal shelf 140 to be in the line of sight with each device. Once the laser device 150 in the line of sight of either the second axle jack, third axle jack, or plumb bob device, the laser device 150 can transmit the laser beam. After the laser beam is transmitted to each device, the distance from the reflection points to the first axle jack 120 can be measured. As mentioned above, the distance of the outer radius to the centerline for each device including that for the first axle jack 120 can be added to the measured distances. The Pythagorean theorem can then be applied to the measured distances to calculate the length of the centerline positioned underneath the vehicle. Accordingly, the Pythagorean theorem can be applied using the measured distances from the first axle 120 jack to the reflection points mentioned above. The vehicle's longitudinal center of gravity in vehicle coordinates can thereby be determined.

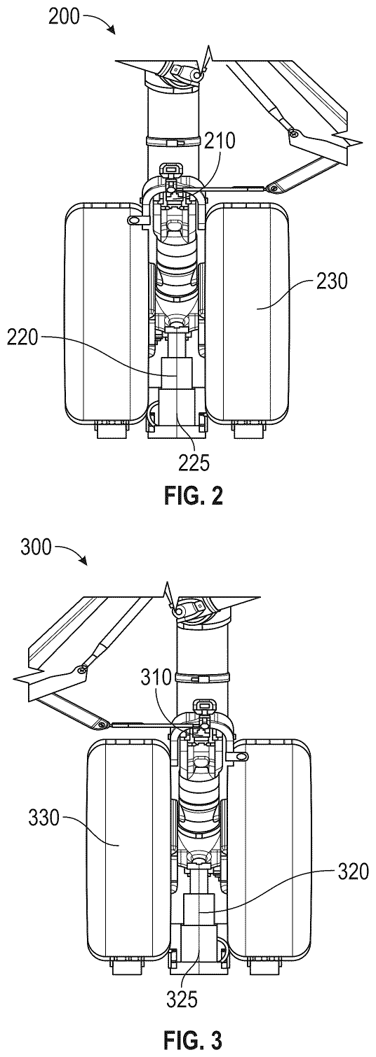

In FIG. 2, with continued reference to FIGS. 1A-1B, a system 200 is illustrated with a left landing gear 210 that can be positioned in a back or rear region underneath the aircraft or vehicle. A second set of wheels 230 above the second axle jack 220 can be lifted off of the ground surface. The second axle jack 220 can also be prepared to receive a laser beam from the laser device. The second axle jack 220 can be positioned underneath the left landing gear 210 and also underneath the second set of wheels 230. The second set of wheels 230 can be lifted off of the ground surface before the second axle jack 220 is prepared to receive the laser beam from the laser device. Before the laser device shown in FIG. 1B transmits a laser beam to the second axle jack 220, a point on the second axle jack 220 can be identified to receive the laser beam. The point can be positioned on a lower cylinder within the second axle jack 220. The laser device can be rotated on the horizontal shelf on the first axle jack shown in FIG. 1B to be in the line of sight to the second axle jack 220.

Referring again to FIG. 2, when the laser device is in the line of sight to the second axle jack 220, the laser device can transmit the laser beam to the second axle jack 220. The laser beam can reflect from a reflection point 225 on the second axle jack 220 back to the first axle jack. A distance from the reflection point 225 to the first axle jack can then be measured. In addition, the distance of an outer radius to a centerline of the second axle jack 220 and the distance of an outer radius to a centerline of the first axle jack can be added to the measured distance. The total measured distance of the second axle jack to the first axle jack can determine a longitudinal position of the first axle jack and the second axle jack 220 along the centerline of the vehicle in vehicle coordinates.

Referring again to FIG. 2, after the distance from the centerline of the first axle jack to the centerline to the second axle jack 220 is calculated, a similar procedure can be performed with a third axle jack and with a plumb bob device. The third axle jack and the plumb bob device can be situated to enable the laser device to transmit the laser beam to their respective reflection points. As a result, the distance from the centerline of the first axle jack to the centerline on the third axle jack and the plumb bob device can then be measured as well.

Referring to FIG. 3, with continued reference to FIGS. 1A-2, a front view of a system 300 is illustrated with a third axle jack 320 positioned underneath a third set of wheels 330 and a right landing gear 310. Load cells can be weighed on the third axle jack 320, and the third set of wheels 330 can be lifted off of the ground surface. The system 300 illustrates a back region of the vehicle or aircraft. In particular, the system 300 illustrates the third axle jack 320 which can be at another angle to the laser device and the first axle jack, and on the right side of the vehicle that can be facing the nose landing gear described in FIGS. 1A-1B. The third axle jack 320 can also be parallel to the second axle jack illustrated in FIG. 2. The third axle jack 320 can be configured to receive the laser beam from the laser device.

In FIG. 3, a point on a bottom cylinder within the third axle jack 320 can be chosen to receive the laser beam from the laser device. The laser device can be rotated on the horizontal shelf on the first axle jack to be in the line of sight of the third axle jack 320. When the laser device is in the line of sight of the third axle jack 320, the laser device can transmit the laser beam to the third axle jack 320. After the laser device has transmitted the laser beam to the third axle jack 320, the distance from a reflection point 325 on the third axle jack 320 to the first axle jack can be measured. In addition, the distance from an outer radius to a centerline of the third axle jack 320 and an outer radius to the centerline of the first axle jack can be added to the measured distance. As such, the total measured distance can include the distance from the centerline of the first axle jack to the centerline of the third axle jack 320. The total measured distance can determine a longitudinal position for both the first axle jack and the third axle jack 320 along the centerline in vehicle coordinates.

After the distances from the centerline from the first axle jack to the reflection points 225, 325 on the second axle jack 220 and third axle jack 320 are measured, the plumb bob device can be situated to receive the laser beam from the laser device. In particular, a plumb bob device can be removably mounted at the front region underneath the vehicle after the first axle jack and the laser device. A point can be identified on a lower portion of the plumb bob device to enable the plumb bob device to receive the laser beam from the laser device.

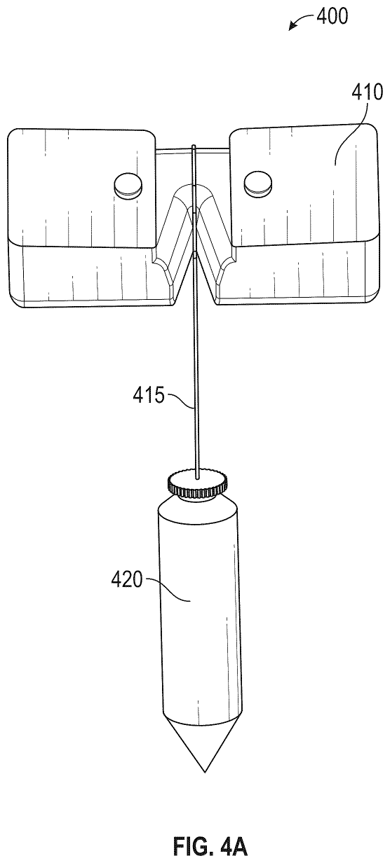

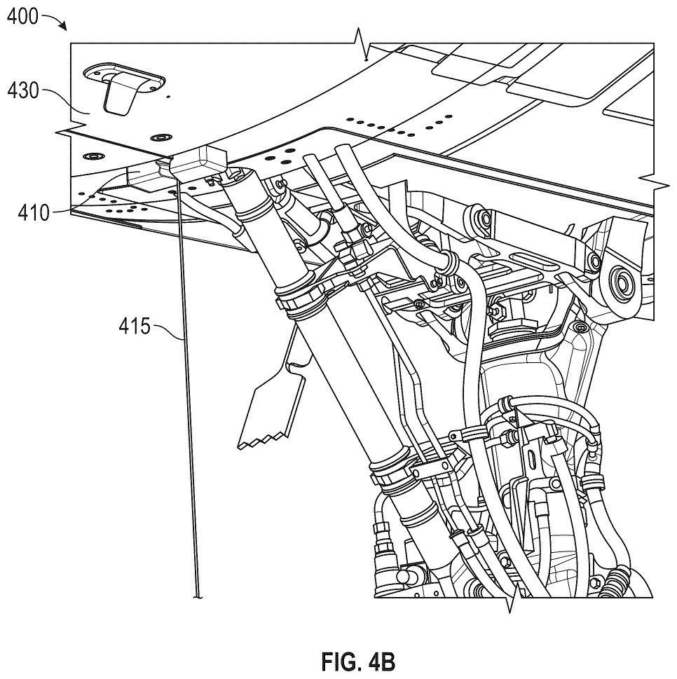

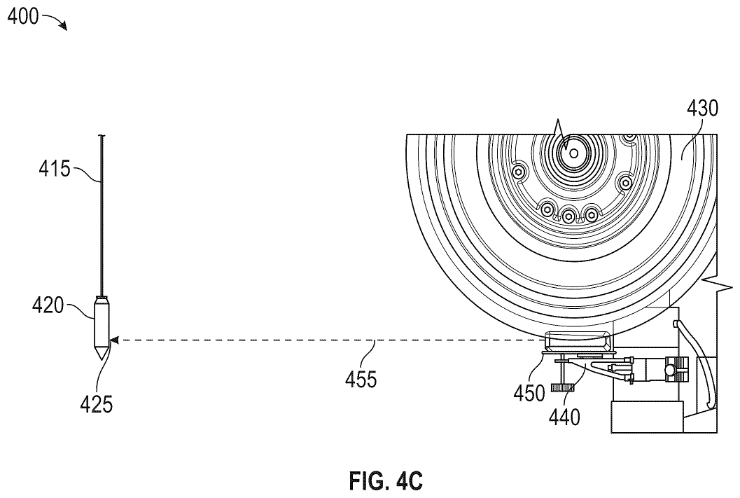

Referring to FIG. 4A, with continued reference to FIGS. 1A-3, a system 400 is illustrated with a holding device 410 and a string 415 configured within the plumb bob device 420. The holding device 410 can work in conjunction with the string 415 and plumb bob device 420. The holding device 410 can be removably mounted at a known reference location on the underside of the fuselage underneath the vehicle. The holding device 410 can be placed underneath and in contact with the fuselage. The string 415 can then be positioned within the holding device 410 and extend in the downward direction. The plumb bob device 420 can be removably mounted to the string 415 and extend in the downward direction. As such, the plumb bob device 420 can then be configured to receive a laser beam from the laser device that is positioned on the first axle jack.

In FIG. 4B, with continued reference to FIGS. 1A-4A, the holding device 410 can be removably mounted into the fuselage 430 of the vehicle. The holding device 410 can be removable and held in place on its own or with a person holding the holding device 410 in place within the fuselage. The string 415 can also be removably mounted within the holding device 410. As shown in FIG. 4B, the string 415 can extend in the downward direction. The holding device 410 and string 415 can be configured at the front region underneath the vehicle. In addition, the holding device 410 and string 415 can be positioned after the first axle jack and the laser device. The holding device 410 and string 415 can also be positioned in front of the second axle jack and the third axle jack that are positioned underneath the rear/back region of the vehicle. Once the holding device 410 and string are removably mounted, the plumb bob device can be attached to the string 415 and extended in the downward direction. The plumb bob device 420 can thereby be positioned after the laser device and first axle jack underneath the front region of the vehicle.

Referring to FIG. 4C, and with continued reference to FIGS. 1A-4B, the plumb bob device 420 can be removably mounted on a bottom portion of the string 415. The plumb bob device 420 can extend downward as well. In addition, after the plumb bob device 420 is removably mounted, the plumb bob device 420 can receive a laser beam 455 from the laser device 450. A lower portion of the plumb bob device 420 can receive the laser beam 455 from the laser device 450. The laser device 450 can be repositioned, if necessary, on the horizontal shelf 440 to be in the line of sight of the plumb bob device 420.

In FIG. 4C, after the laser device 450 is in the line of sight of the plumb bob device 420, the laser device 450 can transmit the laser beam 455 to the plumb bob device 420. The laser beam 455 can then contact a reflection point 425 on the plumb bob device 420, and then reflect back to the first axle jack. As a result, a distance from the reflection point 425 to the first axle jack can be measured. In addition, a distance from an outer radius to a centerline of the plumb bob device 420 and an outer radius to a centerline of the first axle jack can be added to the measured distance. As a result, the centerline from the plumb bob device 420 to the centerline of the first axle jack can be measured. The measured distance from the plumb bob device 420 to the first axle jack can define a position of the first axle jack that is relative to a reference location on the fuselage in vehicle coordinates.

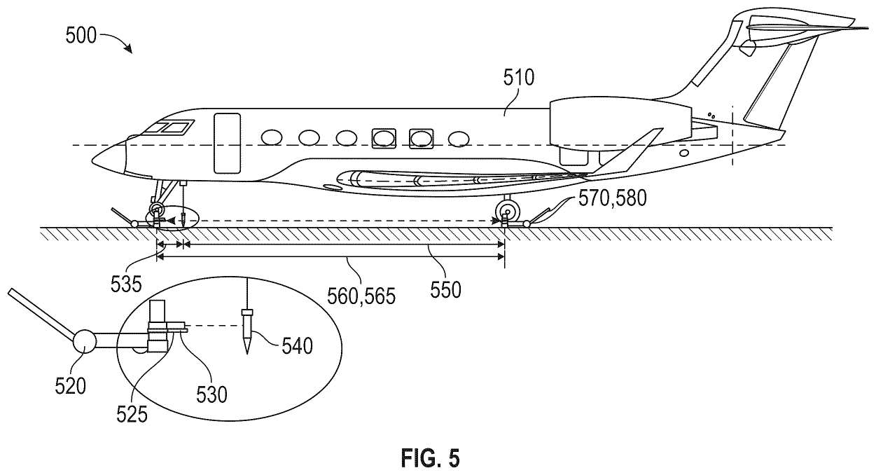

Referring to FIG. 5, with continued reference to FIGS. 1A-4C, a side view of a system 500 is shown. An aircraft or vehicle 510 is positioned in a landing and stationary position on a ground surface. Underneath the vehicle 510 at a nose region or front region of the vehicle 510 can be configured a nose axle jack or first axle jack 520. The first axle jack 520 can be positioned underneath the front region of the vehicle 510 between a first set of wheels. During a weighing procedure, a load cell can be affixed on the first axle jack 520 to determine the weight on the jack. The first set of wheels can also be lifted off of the ground surface as well. A horizontal shelf 525 can be attached or configured onto the first axle jack 520. A laser device 530 can be placed on the first axle jack 520. The laser device 530 can be configured to transmit a laser beam to a plurality of points to measure a distance from reflection points to the first axle jack 520. A plumb bob device 540 can be removably mounted after the first axle jack 520 and laser device 530 at the front region underneath the vehicle 510.

In FIG. 5, the plumb bob device 540 can be removably mounted to a string, which is connected to a holding device. The holding device can be configured within a fuselage underneath the vehicle 510. The plumb bob device 540 can extend in the downward direction. A point can be identified on the plumb bob device 540 to receive a laser beam from the laser device 530. The laser device 530 can be repositioned on the shelf 525 to be in the line of sight with the plumb bob device 540. The laser device 530 can then transmit a laser beam to the plumb bob device 540. After the laser beam has been transmitted to the plumb bob device 540, the laser beam can be reflected from a reflection point on the plumb bob device 540 back to the first axle jack 520. The distance from the reflection point to the first axle jack 520 can be measured. In addition, the distance from an outer radius to a centerline for the plumb bob device 540 and for the first axle jack 520 can be added to the measured distance from the reflection point to the first axle jack 520. As such, the distance 535 from the centerline of the plumb bob device 540 to the centerline of the first axle jack 520 can be measured. The measured distance from the centerline of the plumb bob device 540 to the centerline line of the first axle jack 520 can be used to define a position of the first axle jack 520 relative to a reference location on the fuselage in vehicle coordinates. Further, a distance 550 from the centerline of the plumb bob device 520 to a position between the second axle jack 570 and the third axle jack 580 is illustrated as well below.

Referring again to FIG. 5, a left axle jack or second axle jack 570 can be configured at a back or rear region underneath the vehicle 510 between a second set of wheels. The second axle jack 570 can be positioned at an angle to the laser device 530 and the first axle jack 520. During a weighing procedure, a load cell can be affixed on the second axle jack 570 to determine the weight on the jack. The second set of wheels can also be lifted off of the ground surface as well. The second axle jack 570 can be configured to receive a laser beam from the laser device 530. A point on the lower cylinder of the second axle jack 570 can be identified to receive the laser beam from the laser device. The laser device 530 can be positioned on the horizontal shelf 525 to be in the line of sight of the second axle jack 570. The laser device 530 can then transmit the laser beam to the second axle jack 570. After the laser beam has been transmitted, the laser beam can reflect off of a reflection point on the second axle jack 570 and reflect back to the first axle jack 520. The distance from the reflection point on the second axle jack 570 to the first axle jack 520 can then be measured. In addition, the distance of the outer radius to a centerline for both the second axle jack 570 and the first axle jack 520 can be added to the measured distance. Accordingly, the distance 560 between the centerline of the first axle jack 520 to the centerline of the second axle jack 570 can be accurately measured. The measured distance 560 can determine a longitudinal position along the centerline of the first axle jack 520 and the second axle jack 570 in vehicle coordinates.

In FIG. 5, a right axle jack or third axle jack 580 can also be configured between a third set of wheels at the back region underneath the vehicle 510. The third axle jack 580 can be in parallel to the second axle jack 570. During a weighing procedure, a load cell can be affixed on the third axle jack 580 to determine the weight on the jack. The third set of wheels can also be lifted off of the ground surface as well. The third axle jack 580 can also be situated to receive the laser beam from the laser device 530. A point on a bottom portion or bottom cylinder of the third axle jack 580 can be identified to receive the laser beam from the laser device. The laser device 530 can be rotated on the horizontal shelf 525 to be in the line of sight of the third axle jack 580. When the laser device 530 is in the line of sight with the third axle jack 580, the laser device 530 can transmit another laser beam to the third axle jack 580. The laser beam can reflect off of a reflection point of the third axle jack 580 back to the first axle jack 520. The distance from the reflection point from the third axle jack 580 to the first axle jack 520 can be measured. In addition, the distance from an outer radius to a centerline for both the third axle jack 580 and first axle jack 520 can be determined and added to the measured distance. As a result, the distance 565 from the centerline of the first axle jack 520 to the centerline of the third axle jack 580 can be determined accurately. The measured distance 565 can determine a longitudinal position along the centerline for the first axle jack 520 and third axle jack 580 in vehicle coordinates.

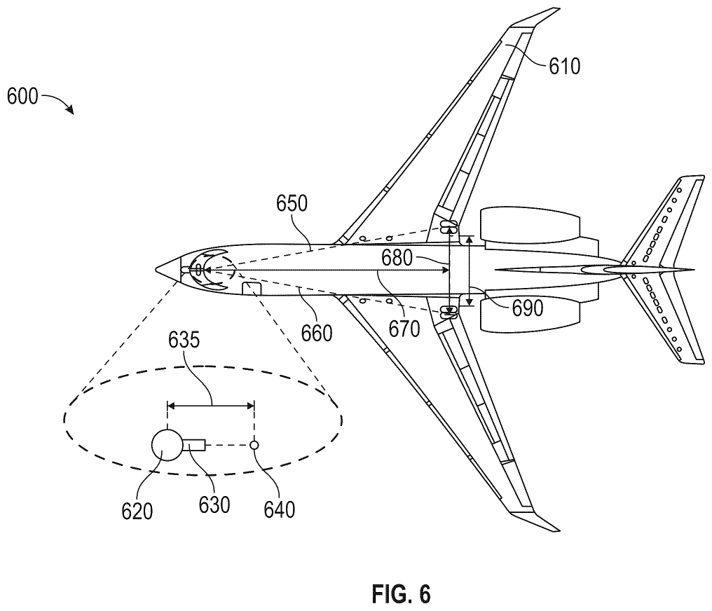

Referring to FIG. 6, with continued reference to FIGS. 1A-5, a plan view of a system 600 is illustrated. The system 600 illustrates how measured distances from reflection points can be used to identify a length or distance B, 670 of a centerline region underneath the aircraft or vehicle 610. The system 600 illustrates a distance C, 635 from a centerline of a first axle jack 620 to a centerline of a plumb bob device 640. The system 600 can also illustrate a distance E, 650 from a centerline of the first axle jack 620 to a centerline of a left axle jack or second axle jack. The system 600 also illustrates a distance D, 660 from the centerline of the first axle jack to a centerline of a right axle jack or third axle jack. In addition, the system 600 illustrates a distance F, 680 from the centerline of the second axle jack to the centerline of the third axle jack. The distance F, 680 can be a known distance that does not need to be measured. The system 600 also illustrates a distance G, 690, which indicates a distance between inner wheel hubs between the second axle jack and the third axle jack. The distance G, 690 can also be a known distance as well.

In FIG. 6, the Pythagorean theorem can be applied to measure the distance B, 670 along the centerline region underneath the vehicle 610. The equations that can be used to lead to the Pythagorean theorem can include:

$${D}^{2} = {B}_{L}^{2} + {( F / 2 )}^{2} , and \qquad ( 1 )$$

$${E}^{2} = {B}_{R}^{2} + {( F / 2 )}^{2} . \qquad ( 2 )$$

In the equations (1) and (2), BL can represent the distance B, 670 along the centerline on a left-hand region underneath the vehicle 610, while BR can represent the distance B, 670 along the centerline on a right-hand region underneath the vehicle 610. The equations (1) and (2) can be rearranged as the following: (3) B_{L}=√\vec{D²−(F/2)²}, and (4) B_{R}=√\vec{E²−(F/2)²}. Further, equation (5) can include: B=½(B_{L}+B_{R}).

Still referring to FIG. 6, and inserting equation (3) for BL and equation (4) for BR into equation (5), the Pythagorean theorem can then be obtained by the following equation:

$$B = \frac{1}{2} ( \sqrt{{D}^{2} - \frac{1}{4} {F}^{2}} + \sqrt{{E}^{2} - \frac{1}{4} {F}^{2}} ) . \qquad ( 6 )$$

As a result, the distance B, 670 along the centerline underneath the vehicle 610 can be measured. The distance B, 670 can extend from the centerline of the first axle jack 620 to a point between the second axle jack and the third axle jack at the rear region underneath the vehicle 610. The distance D, 660 can extend from the centerline of the first axle jack 620 to the centerline of the third axle jack. The distance F, 680 can be a known distance between the centerline of the second axle jack to the centerline of the third axle jack. As mentioned above, the distance F, 680 may not need to be measured. The distance E, 650, can be the centerline of the first axle jack to the centerline of the second axle jack. By using the using the measurements for the distances D, 660, F, 680, and E, 650 in equation (6), the length or distance B, 670 along the centerline underneath the vehicle 610 can be determined. Accordingly, the distance B, 670 along the centerline underneath the vehicle 610 can be accurately measured. Overall, the distance E, 650, the distance D, 660 and the distance F, 680 can determine the longitudinal distance B, 670 along the centerline between the first axle jack and the average of the second axle jack and the third axle jack positions. As such, the measured longitudinal distance B, 670 can be used to determine the vehicle's longitudinal center of gravity in vehicle coordinates.

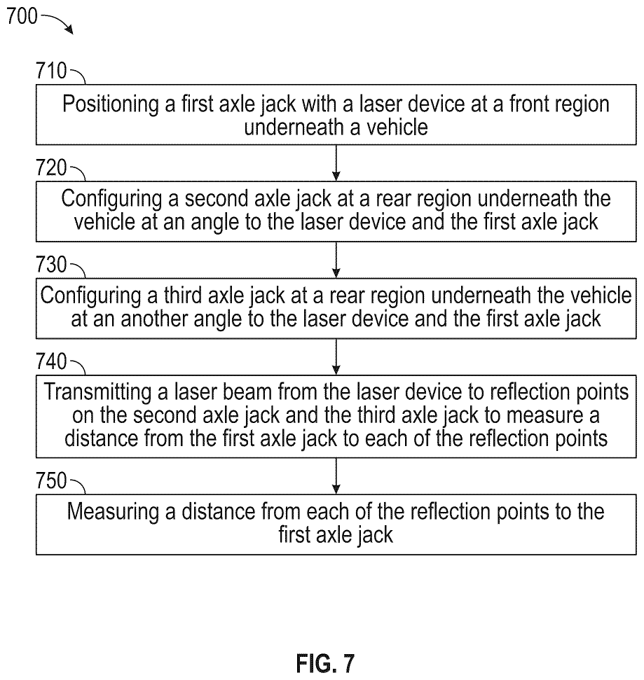

Referring to FIG. 7, with continued reference to FIGS. 1A-6, a flow diagram 700 is illustrated that describes a process in which the length of a centerline underneath vehicle is determined during the weighing of an aircraft or vehicle. The flow diagram 700 illustrates a more efficient way of measuring distances from reflection points underneath the vehicle without causing any damage to the vehicle. The Pythagorean theorem can then be applied to the measured distances to determine the distance of the length of the centerline underneath the vehicle. The length of the centerline underneath the vehicle can extend from a centerline of a first axle underneath the nose region of the vehicle to a point between a second axle jack and third axle jack at a back region underneath the vehicle. As a result, a more efficient means of measuring the length of the centerline underneath the vehicle can be measured with a less likelihood of damage occurring to the vehicle. Moreover, the vehicle's longitudinal center of gravity in vehicle coordinates can be determined safely and efficiently.

In FIG. 7, at step 710, the first axle jack can be positioned at the nose region or front region underneath the vehicle. The first axle jack be positioned within a first set of wheels at a front region underneath the vehicle with a laser device configured on the first axle jack. A load cell can be used on the first axle jack to measure the weight on the jack. The first set of wheels can also be lifted off of the ground surface. After the weight is measured using the load cell, a horizontal shelf can be positioned on the first axle jack. After the horizontal shelf is configured on the first axle jack, the laser device can then be configured on the horizontal shelf. The laser device can be rotated and repositioned on the horizontal shelf to place the laser device in the line of sight to points on the second axle jack, the third axle jack, and a plumb bob device.

Referring to FIG. 7, at step 720, the second axle jack can be positioned at a back region underneath the vehicle. The second axle jack can be positioned at the back region or rear region underneath the vehicle between a second set of wheels. A load cell can be used on the second axle jack to measure the weight on the jack. The second set of wheels can also be lifted off of the ground surface as well. The second axle jack can be positioned at an angle to the laser device and the first axle jack. The second axle jack can be configured to receive a laser beam from the laser device. The laser beam can be transmitted to a point on the second axle jack and reflect back to the first axle jack The measured distance from the reflection point of the second axle jack to the first axle jack, and the outer radius to centerline of the first axle jack and second axle jack can be added to the measured distance. The measured distance can determine a longitudinal position along the centerline for the first axle jack and the second axle jack in vehicle coordinates.

In FIG. 7, at step 730, the third axle jack can also be positioned at a back region underneath the vehicle. The third axle jack can be positioned at the rear region underneath the vehicle between a third set of wheels, wherein the third axle jack is positioned at another angle to the laser device and the first axle jack. The third axle jack can also be positioned in parallel to the second axle jack. A load cell can be used on the third axle jack to measure the weight on the jack. The third set of wheels can also be lifted off of the ground surface. The third axle jack can also be configured to receive a laser beam from the laser device on the first axle jack. The laser device can transmit a laser beam to point on the third axle jack. The laser beam can reflect off a reflection point of the third axle jack and back to the first axle jack. The measured distance can include the distance from the reflection point to the first axle jack, and the distance from the outer radius to centerline for both the first axle jack and the third axle jack. The measured distance can determine a longitudinal position along the centerline for the first axle jack and the third axle jack in vehicle coordinates.

In FIG. 7, at step 740, the laser device on the first axle jack can transmit a laser beam to a point on the second axle jack, third axle jack, and plumb bob device. In each iteration, the laser beam can reflect off a reflection point off the second axle jack, the third axle jack, and the plumb bob device and travel back to the first axle jack. The distance from each reflection point to the first axle jack can be measured.

In FIG. 7, at step 750, the distance from the first axle jack to each of the reflection points can be measured. In addition, the distance of an outer radius to a centerline for the first axle jack, second axle jack, third axle jack, and plumb bob device can be added to the measured distances from the reflection points to the first axle jack. As a result, the distance from the centerline of the first axle jack to the centerline of the second axle jack, the centerline of the first axle jack to the centerline of the third axle jack, and the centerline of the first axle jack to the centerline of the plumb bob device can be measured. The measured distances from the centerline of the first axle jack to the centerline of the second axle jack, the centerline of the first axle jack to the centerline of the third axle jack, and the known distance between the centerline of the second axle jack to the centerline of the third axle jack can be used in the Pythagorean theorem. The Pythagorean theorem, illustrated by equation (6)

$$B = \frac{1}{2} ( \sqrt{{D}^{2} - \frac{1}{4} {F}^{2}} + \sqrt{{E}^{2} - \frac{1}{4} {F}^{2}} ) ,$$

can be applied to measure the distance or length of the centerline underneath the vehicle. As mentioned above, the length of the centerline can extend from the first axle jack underneath the front region or nose region of the vehicle to the back region underneath the vehicle to a position between the second axle jack and the third axle jack. Accordingly, the vehicle's longitudinal center of gravity in vehicle coordinates can be determined during a weighing procedure.

In another embodiment, and as illustrated in FIG. 5, the length of the centerline underneath the vehicle can also be measured by adding the measured distance from the centerline of the first axle jack to the centerline of the plumb bob device to the measured distance from the centerline of the plumb bob device to the position between the second axle jack and third axle jack.

The embodiments described above in FIGS. 1-7 more efficiently identify the distance along the centerline underneath the aircraft or vehicle which may be necessary, for example, during the weighing of the vehicle. The vehicle's longitudinal center of gravity in vehicle coordinates can be determined safely and efficiently. The first set of wheels, the second set of wheels, and the third set of wheels can be lifted off of the ground surface until the vehicle is laterally and longitudinally level. The first set of wheels can be lifted to a greater height than the second set of wheels and the third set of wheels. The laser device can transmit a laser beam to points on the second axle jack, the third axle jack, and the plumb bob device. In each iteration, the laser beam can reflect back from a reflection point on the second axle jack, the third axle jack, and the plumb bob device back to the first axle jack. The distances from the first axle jack to the reflection points on the second axle jack, the third axle jack, and the plumb bob device can be measured. The distance of an outer radius to a centerline for first axle jack, the second axle jack, the third axle jack, and the plumb bob device can be added to the measured distances. Longitudinal positions along the centerline for the first axle jack, second axle jack, and third axle jack in vehicle coordinates can be determined as a result.

The total measured distances can include the distance from the centerline of the first axle jack to the centerline of the second axle jack, the third axle jack, and the plumb bob device. The Pythagorean theorem can be applied to the measured distances to determine the length of the centerline extending from the first axle jack to the position between the second axle jack and the third axle jack. The length of the centerline can be determined safely and efficiently during the weighing of the vehicle in less time than other methods, with increased accuracy, and with no unnecessary damage occurring to the vehicle.

While at least one exemplary embodiment has been presented in the foregoing detailed description of the disclosure, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the disclosure as set forth in the appended claims.

What is claimed is:

1. A method for determining a length along a centerline underneath a vehicle, the method comprising:
positioning a first axle jack within a first set of wheels at a front region underneath the vehicle with a laser device configured on the first axle jack;
positioning a second axle jack at a rear region underneath the vehicle between a second set of wheels, wherein the second axle jack is positioned at an angle to the laser device and the first axle jack;
positioning a third axle jack at the rear region underneath the vehicle between a third set of wheels, wherein the third axle jack is positioned at another angle to the laser device and the first axle jack;
transmitting a laser beam from the laser device to reflection points on the second axle jack and the third axle jack to measure a distance from the first axle jack to each of the reflection points; and
measuring a distance from each of the reflection points to the first axle jack.

2. The method of claim 1, further comprising:
removably mounting a plumb bob device at the front region underneath the vehicle aft of the first axle jack and the laser device.

3. The method of claim 2, further comprising:
transmitting a laser beam from the laser device to a reflection point on the plumb bob device to measure a distance from the reflection point on the plumb bob device to the first axle jack.

4. The method of claim 1, further comprising:
rotating the laser device on a shelf in multiple intervals to face the second axle jack and the third axle jack before emitting the laser beam.

5. The method of claim 2, further comprising:
removably mounting a holding device underneath the vehicle to allow the plumb bob device to hang below a known reference point on a centerline of the vehicle aft of the first axle jack.

6. The method of claim 2, further comprising:
identifying a bottom portion of the plumb bob device to receive the laser beam before positioning the laser device to emit the laser beam to the plumb bob device.

7. The method of claim 1, further comprising:
rotating the laser device on a shelf to place the laser device in a line of sight of a bottom cylinder configured within with the third axle jack.

8. The method of claim 1, further comprising:
raising the first set of wheels configured around the first axle jack at the front region to a greater height than the second set of wheels configured around the second axle jack and the third set of wheels configured around the third axle jack.

9. The method of claim 1, further comprising:
determining the length along the centerline underneath the vehicle by measuring a distance from a centerline of the first axle jack to a centerline of the second axle jack, a distance from the centerline of the first axle jack to a centerline of the third axle jack, and a distance from the centerline of the second axle jack to the centerline of the third axle jack using the laser device.

10. The method of claim 2, further comprising:
determining the length along the centerline underneath vehicle by adding a distance from a centerline of the first axle jack to the plumb bob device and a distance from the plumb bob device to a position between the second axle jack and the third axle jack.

11. A method for determining a length along a centerline underneath a vehicle, the method comprising:
positioning a first axle jack under a front region of the vehicle between a first set of wheels at the front region with a laser device positioned on the first axle jack;
positioning a second axle jack at a rear region underneath the vehicle between a second set of wheels and at an angle to the laser device and the first axle jack;
positioning a third axle jack at the rear region underneath the vehicle between a third set of wheels and at another angle to the laser device and the first axle jack;
removably mounting a plumb bob device to extend downwardly at the front region underneath the vehicle between the first axle jack, the laser device, the second axle jack, and the third axle jack;
transmitting a laser beam from the laser device to reflection points on the second axle jack, the third axle jack, and the plumb bob device to measure a distance from the first axle jack to each of the reflection points; and
calculating the length of the centerline underneath the vehicle using the measured distances from the first axle jack to each of the reflection points.

12. The method of claim 11, further comprising:
lifting the vehicle off a ground surface until laterally and longitudinally level before transmitting the laser beam to each of the reflection points.

13. The method of claim 11, further comprising:
raising the first set of wheels, the second set of wheels, and the third set of wheels before transmitting the laser beam to each of the reflection points.

14. The method of claim 13, further comprising;
raising the first set of wheels to a greater height than the second set of wheels and the third set of wheels.

15. The method of claim 11, further comprising:
identifying a center point of a lower cylinder configured within the second axle jack to receive the laser beam from the laser device.

16. The method of claim 11, further comprising:
determining the length along the centerline underneath the vehicle with a Pythagorean theorem by using the measured distance from a centerline of the first axle jack to a centerline of the second axle jack, the measured distance from the centerline of the first axle jack to a centerline of the third axle jack, and a distance from the centerline of the second axle jack to the centerline of the third axle jack.

17. A system for determining a length along a centerline underneath a vehicle, the system comprising:
a first axle jack positioned under a front region of the vehicle between a first of wheels at the front region with a laser device positioned on the first axle jack;
a second axle jack positioned at a rear region underneath the vehicle between a second set of wheels and at an angle to the laser device and the first axle jack;
a third axle jack positioned at the rear region underneath the vehicle between a third set of wheels at another angle to the laser device and the first axle jack;
a plumb bob device removably mounted to extend downwardly at the front region underneath the vehicle in between the first axle jack, the laser device, the second axle jack, and the third axle jack; and
reflection points on the second axle jack, the third axle jack and the plumb bob device, wherein the laser device transmits a laser beam to each of the reflection points to measure a distance from the first axle jack to each of the reflection points, wherein the measured distances from each of the reflection points to the first axle jack are used to calculate the length along the centerline underneath the vehicle.

18. The system of claim 17, wherein the first set of wheels are positioned at a greater height than the second set of wheels and the third set of wheels before the laser device emits the laser beam to each of the reflection points.

19. The system of claim 17, further comprising:
a holding device to hold the plumb bob device in place to enable the laser device to emit the laser to the reflection point on the plumb bob device.

20. The system of claim 17, wherein laser device is rotated on a horizontal shelf to place the laser device in a line of sight to the second axle jack or the third axle jack.
